(19) United States
(12) Patent Application Publication
(10) Pub. No.: US 2014/0002610 A1
(43) Pub. Date: Jan. 2, 2014

(54) REAL-TIME 3D SHAPE MEASUREMENT SYSTEM

(71) Applicants: Ning Xi, Okemos, MI (US); Jing Xu, East Lansing, MI (US); Chi Zhang, Lansing, MI (US)

(72) Inventors: Ning Xi, Okemos, MI (US); Jing Xu, East Lansing, MI (US); Chi Zhang, Lansing, MI (US)

(73) Assignee: BOARD OF TRUSTEES OF MICHIGAN STATE UNIVERSITY, East Lansing, MI (US)

(21) Appl. No.: 14/005,207

(22) PCT Filed: Mar. 14, 2012
(86) PCT No.: PCT/US12/29048

§ 371 Date: Sep. 13, 2013

Related U.S. Application Data
(60) Provisional application No. 61/452,840, filed on Mar. 15, 2011.

(51) Int. Cl. G01B 11/25

(52) U.S. Cl. CPC G01B 11/2545
USPC 348/46

(57) ABSTRACT

Improved method and system for performing three-dimensional shape inspection by: projecting a pattern of light onto an object of interest with a projector, the pattern of light being constituted by a plurality of symbols of different shapes; capturing an image of the illuminated object with an image capturing device; determining the 3D shape of the object from the image data and the projected light pattern with a processor using triangulation. The pattern of light is projected in an omnidirectional plane by means of a first mirrored surface having hyperbolic shape to provide an alternative to traditional monochromatic light based patterns.

### CROSS-REFERENCE TO RELATED APPLICATIONS

This application claims the benefit of U.S. Provisional Application No. 61/452,840, filed on Mar. 15, 2011. The entire disclosure of the above application is incorporated herein by reference.

### FIELD

The present disclosure relates to a three-dimensional shape measurement system based on a single structure light pattern.

### BACKGROUND

In the automotive industry, there has been an increasing requirement to rapidly measure the 3D shapes of the automotive parts instead of traditional coordinate measurement machine (CMM), one of the contact measurement sensors. The dimensional inspection using CMM is time consuming since the part can only be measured point by point. To overcome such a drawback, the non-contact 3D inspection system based on structured light has been successfully achieved in a variety of applications. A white light area sensor usually contains two parts, a projector and a imaging device: the projector is used to put a set of encoded structured light patterns on the part surface such that the imaging device can decode those patterns for acquisition of 3D part shape using triangulation measurement technique. The encoded pattern affects all of the measurement performance such as accuracy, precision, point density, and time cost, etc.

Many different structured light pattern codification strategies have been developed. They can be mainly categorized as time multiplexing, direct coding, and spatial neighborhood. The strategy based on time multiplexing is easy to implement and can achieve a high accuracy and resolution performance. At present, the Gray Code and Phase Shifting (GCPS) and Gray Code and Line Shifting (GCLS) are widely used in shape measurement system for quality inspection in the automotive industry. However, such systems have the following main drawbacks: the inspected part must not move while the coded patterns are being obtained since the multiply patterns should be projected in sequence. Otherwise, the system may acquire incorrect stripe and result in inaccurate 3D shape. Thus, the combination of the space and time in each stripe boundary of patterns is used so that the time consistency and the number of fringe patterns can be reduced. Actually, this strategy is still a multi-shot pattern which cannot deal with the fast moving part. For this purpose, the method for direct coding based on every point containing the entire codeword in a unique pixel is developed; however, it is very sensitive to the noise because a large range of color values are adopted in such a pattern.

In the strategy of spatial neighbor pattern, the codeword of each primitive (element) depends on its value and those of its neighbor so that the codeword can be determined in a unique pattern. Therefore, it can be used as one shot pattern for real time 3D shape measurement. The most typical one shot pattern based on spatial neighbor is constructed with stripe pattern (parallel adjacent bands), multiply slits (narrow bands separated by black gaps), and sparse dots (separated dots on the black background). The efficient way to encode these patterns is based on color so that pixel codeword can be determined by different colors around it. In practice, the reliability of the color pattern is lower than those from monochromatic light (black and white) pattern because color contrast is affected by inspected object color reflectance and ambient light. To solve this problem, neighbor strategy based on black/white pattern is used for an inspection system. However, the number of neighbors increases for encoding each primitive because the possibility of color value for each primitive decreases. To solve such a problem, some authors develop patterns based on the geometrical feature of the primitive instead of color. In this case, the required number of coding length depends on the number of different geometrical features of the primitive.

To satisfy the requirement of the real time measurement for the automotive production lines, the structured light pattern should simultaneously satisfy the robustness, accuracy, and real-time performance. However, the existing patterns have not been achieved in the real-time measurement for automotive parts, such as pillow and windshield. Therefore, it is desirable to develop a new structured light pattern for a three-dimensional measurement system.

This section provides background information related to the present disclosure which is not necessarily prior art.

### SUMMARY

An improved method is provided for performing three-dimensional shape inspection. The method includes: generating a pseudorandom sequence of values; constructing a pattern of light comprised of a plurality of symbols from the pseudorandom sequence of values, where each type of symbol in the pattern of light having a different geometric shape and encoding a different value in the pseudorandom sequence of values; projecting the pattern of light from a light projector onto an object of interest, where the pattern of light is projected along an epipolar line defined by an intersection of an epipolar plane with an image plane of the light projector; capturing image data indicative of the object using an imaging device; and determining a measure for the object from the image data and the pattern of light projected onto the object.

In another aspect of this disclosure, the improved structured light pattern may be extended to develop an omnidirectional three dimensional inspection system. The omnidirectional system includes: a projector operable to project a pattern of light in a projected direction towards an image plane and onto a first mirrored surface having a hyperbolic shape, such that the pattern of light is projected as omnidirectional ring about the projector; an imaging device disposed adjacent to the projector and having an image plane arranged in parallel with the image plane of the projector, wherein the imaging device is configured to capture image data reflected from a second mirrored surface having a hyperbolic shape and the second mirrored surface faces towards the first mirrored surface; and an image processor configured to receive the image data from the imaging device and operable to determine a measure for an object from the image data by using the pattern of light projected by the projector.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a diagram of a typical non-contact shape inspection system;

FIG. 2 is a diagram illustrating epipolar geometry of the inspection system;

FIG. 3 is a diagram illustrating an exemplary pseudorandom sequence generator;

FIG. 4 is a diagram illustrating exemplary geometric shapes for primitives used to constructed the light pattern;

FIG. 5 is a flowchart depicting an exemplary technique of pattern detection and identification as carried out by the image processor;

FIG. 6 is diagram illustrating a recursive search algorithm that may be used for pixel matching;

FIG. 7 is a diagram depicting an exemplary coordinate system used for calibrating the inspection system;

FIG. 8 is a diagram depicting an exemplary omnidirectional three dimensional inspection system;

FIGS. 9A and 9B are diagram illustrating a vector-based calibration strategy for an imaging device and projector, respectively;

FIG. 10 is a diagrams depicting an image warp for a panoramic view;

FIG. 11 is a diagram of an exemplary projection pattern used by the omnidirectional inspection system;

FIG. 12 is a diagram illustrating the epipolar geometry of the omnidirectional inspection system; and

FIG. 13 is a diagram depicting construction of an exemplary projector which may be used to project the light pattern.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

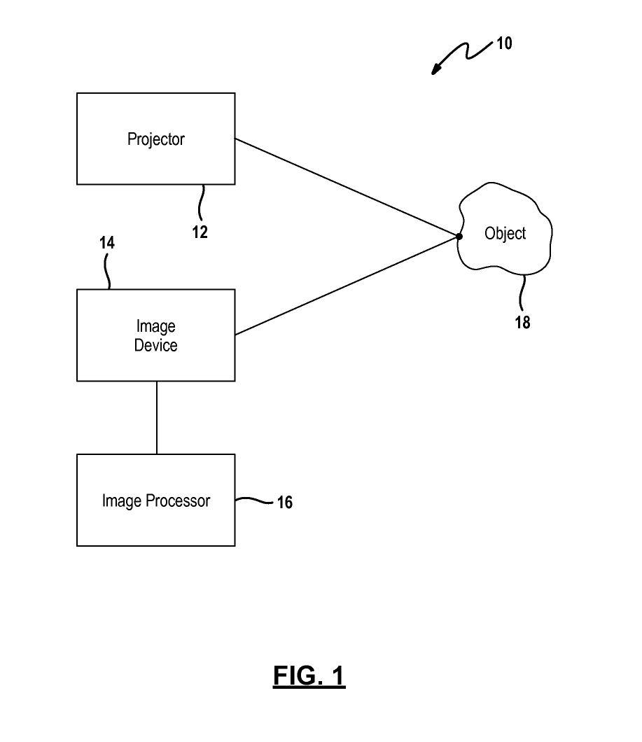

FIG. 1 illustrates components of a typical triangulation-based non-contact shape inspection system 10. The inspection system 10 is comprised generally of a projector 12, an imaging device 14 and an image processor 16. In operation, the projector 12 projects structured light towards a surface of an object of interest 18 and the imaging device 14 (e.g., a CCD) captures image data indicative of the object 18. The image processor 16 is configured to receive the image data from the imaging device 14 and measure points on the surface of the inspected object 18 using triangulation. Once the correspondence problem is solved using the structured light pattern, the surface point of the measured part shape can be reconstructed. It is envisioned that the image processor 16 may be integrated with the imaging device 14 into a single housing or implemented by a computing device independent from the imaging device 14.

Epipolar geometry of the inspection system 10 is further illustrated in FIG. 2. In such a system, the projector 12 can also be regarded as an inverse imaging device for it projects images instead of capturing them. Hence, the epipolar geometry in stereo vision can be utilized as one constraint of the pattern design for the structured light and correspondence search. Consider P is a point on the surface of inspected object; p_{c} and pₚ are the projections of the point P on the imaging device image plane I_{c} and the projector image plane Iₚ, respectively. Additionally, O_{c} and Oₚ are the focal points of the imaging device 14 and the projector 12, respectively. Each focal point projecting onto other image plane forms two image points e_{c} and eₚ, named epipolar or epipolar point. Therefore, P, pₑ, pₚ, O_{c}, Oₚ, e_{c} and eₚ are coplanar. The plane is known as epipolar plane. The intersection of the epipolar plane with the camera image plane I_{c} and the projector image plane Iₚ, respectively, are called the epipolar line and denoted by I_{c} and Iₚ, respectively. Thus, the corresponding points, p_{c} and pₚ are constricted by:

p_{c}^{T}·F·pₚ=0 (1)

where F is the fundamental matrix. The two corresponding epipolar lines l_{c} and lₚ satisfy

l_{c}=F[eₚ]ₓlₚ (2)

where [eₚ]ₓ denotes 3×3 skew symmetric matrix. If eₚ=[e₁ e₂ e₃]^{T}, then the corresponding skew symmetric matrix can be represented as:

$${[ {e}_{p} ]}_{x} = [ \begin{matrix}0 & - {e}_{3} & {e}_{2} \\ {e}_{3} & 0 & - {e}_{1} \\ - {e}_{2} & {e}_{1 } & 0\end{matrix} ]$$

Once the fundamental matrix is calibrated, the projector image plane and the camera image plane can be divided by a series of epipolar lines. Then, the structure pattern is developed along each epipolar line. As a result, the pattern design and the correspondence problem are reduced from the traditional two-dimensional search (the whole image) to one-dimensional search problem (along the epipolar line). Thus, the algorithm will be significantly accelerated compared with the conventional strategies.

To simplify the corresponding point search in the image planes for the projector 12 and the imaging device 14, let the epipolar lines uniformly distribute on the projector image plane. The line connecting the optical centers of the imaging device and projector (baseline) is preferably parallel to both the scan lines of the image plane for the imaging device and projector (in other words, the epipolar lines are parallel to horizontal image axes). For this purpose, the relative position and orientation between the projector 12 and the imaging device 14 can be roughly adjusted based on the result of calibration. Then, the two image planes can be further rectified. The rectified image can be regarded as acquired by the optical device rotated with respect to the original one.

Techniques for constructed a suitable pattern of light are described below. Patterns based on spatial neighbors can be generated by a brute-force algorithm to obtain the desired characteristics without any mathematical background. In general, this approach is not optimal and robust. Alternatively, the pattern may be developed using a well-known type of mathematical sequence, such as De Bruijn sequence. A De Bruijn sequence of order m over an alphabet of q symbols is a circular sequence of length q^{m} length that contains each substring of length m exactly appearing once. It is envisioned other types of mathematical sequences may also be used to develop the pattern.

Similarly, a pseudorandom sequence is a length of q^{m}−1 circular sequence without the subsequence formed by 0, where q is a prime or a power of prime. Then, any substring of length m also exactly appearing once according to its window property. In an exemplary embodiment, the pseudorandom sequence is generated by a primitive polynomial with coefficients from the Galois field GF(q)

h(x)=x^{m}+hₘ₋₁x^{m-1}+ . . . +h₁x+h₀ (3)

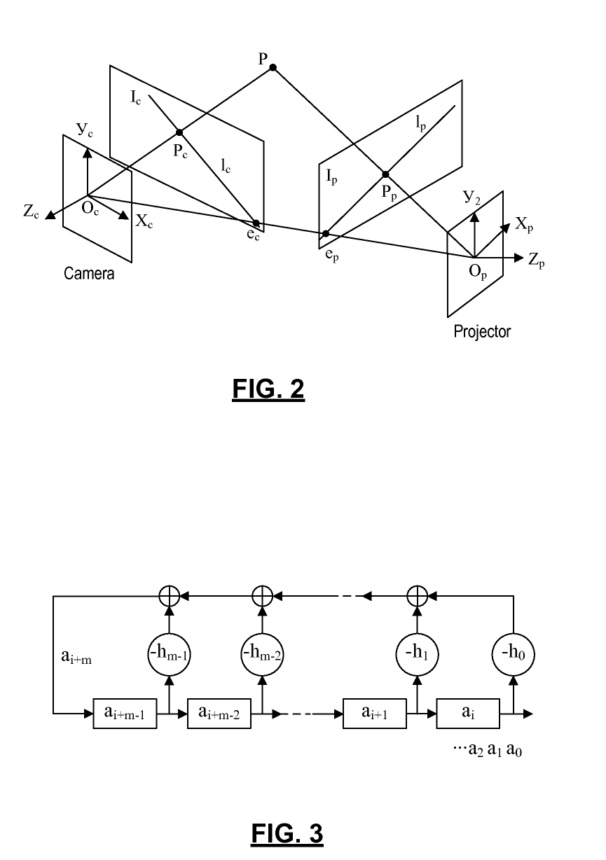

This polynomial defines a feedback shift register as shown in FIG. 3. In FIG. 3, the boxes contain the elements of GF(q) named aᵢ₊ₘ₋₁, . . . aᵢ, such that the feedback path then forms aᵢ₊ₘ=−hₘ₋₁aᵢ₊ₘ₋₁−hₘ₋₂aᵢ₊ₘ₋₂+ . . . +h₁aᵢ₊₁−h₀aᵢ. The Galois field GF (q) elements are expressed as

GF(q)={0,1,A,A², . . . A^{q-2}} (5)

Some exemplary primitive polynomials are shown in Table I below.

TABLE 1
PRIMITIVE POLYNOMIAL OVER GF(Q)

| deg (m) | q = 3 | q = 4 | q = 8 |
|---|---|---|---|
| 1 | x + 1 | x + A | x + A |
| 2 | x² + x + 2 | x² + x + A | x² + Ax + A |
| 3 | x³ + 2x + 1 | x⁺ x² + x + A | x³ + x + A |
| 4 | x⁴ + x + 2 | x⁴ + x² + Ax + A² | x⁴ + x + A³ |
| 5 | x⁵ + 2x + 1 | x⁵ + x + A | x⁵ + x² + x + A³ |

In this disclosure, the feedback path defined by the primitive polynomial h(x)=x³+x²+A over GF(4) {0,1,A,A²} with A²+A+1=0 and A³=1 is used along each epipolar line of the projector image plane.

Along each epipolar line, a pseudorandom sequence with length of 63 is generated. For illustration purposes, one sequence is shown as: 110312223221020213100220123331332030321200330231112113010132300. It is readily understood that sequences of varying lengths as well as other means for generating the pseudorandom sequence are within scope of this disclosure.

Design a good primitive of the pattern is critically important for achieving accurate correspondence with optical triangulation technique, especially a one shot method. The primitive design should satisfy the following constraints: (a) monochromatic light; and (b) robust and accurate detection.

Taking into account the monochromatic light, the symbol should not contain color coding information. Hence, symbols with geometrical features will be adopted, instead of the traditional color based coding patterns. The image feature should be accurately extracted and solve the problem of shadows and occlusions. The center symmetry symbol, such as circle, disc etc, is widely used for fringe pattern and the intensity centroid of the symbol is regarded as the symbol location. However, a partial occlusion affects the centroid position.

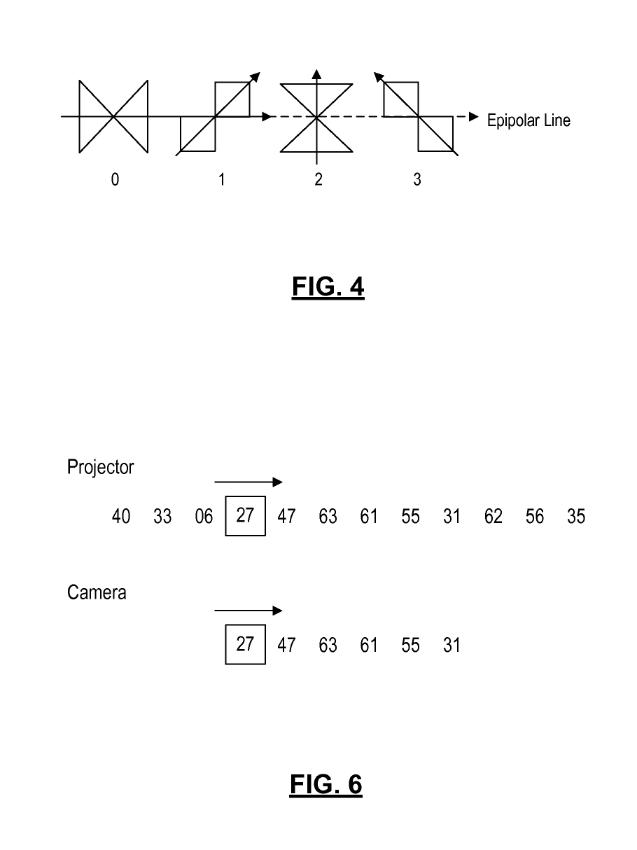

In this disclosure, the strategy determines the symbol location with the corner of high contrast checkerboard. FIG. 4 illustrates exemplary geometric shapes for the primitive in accordance with this strategy. The portions of the primitives hidden by smudges or occlusions are disregarded, with no significant impact on accuracy. Additionally, a disc in an image does not contain any geometrical information other than its center's location. In contrast, the proposed geometric shapes have both a location and an orientation. This additional characteristic is used to discriminate the different symbols in the epipolar line. As shown in FIG. 4, the arrow denotes the orientation of the symbol and its corresponding code. The angle between the principle axis (in this case, the longitudinal axis) of the symbol and the epipolar line are 0,π/4, π/2, 3π/4 and corresponding codes are 0, 1, 2, 3, respectively. Moreover, misleading bright reflection spots are more often naturally found in a measurement environment than the proposed geometric shapes for the primitives. Therefore it is easy to remove the noise caused by bright spots when using the proposed geometric shapes as the primitive.

While reference has been made to particular geometric shapes, broader aspects of this disclosure extend to other types of primitives. For example, the pattern can be a grid of black and white squares which can be generated by window shifting with the constraint of minimum hamming distance.

In this case, area matching is used to figure out the correspondence between the projector and imaging device. Patterns may also be constructed of primitives having other geometrics shapes including but not limited to discs, circles, stripes, etc.

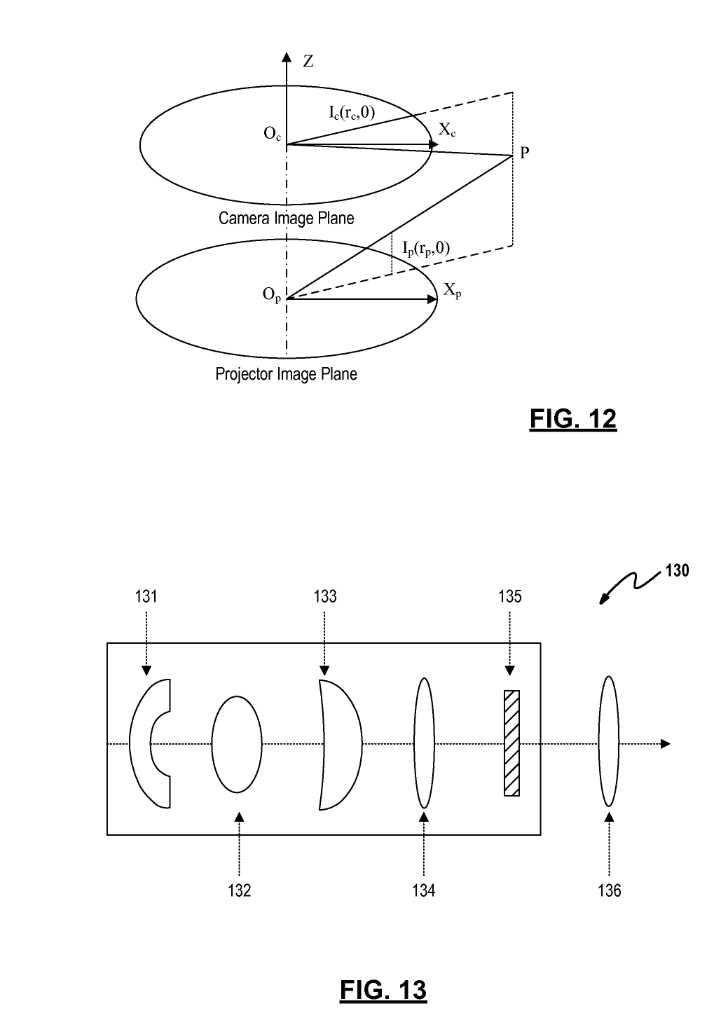

FIG. 13 depicts construction of an exemplary projector 130 which may be used to project the light pattern. The projector is comprised of a reflector mirror 131, a light source 132, a sphere-lens 133, a plan-convex lens 134 and a projection lens 136. In the exemplary embodiment, the light source 132 for the projector 130 is the high-power 940 nm LED light and collimated onto the glass-based gobo 135 through the sphere-lens 133 and plan-convex lens 134 as shown. The glass gobo 135 is a piece of opaque glass with a set of designed transparent patterned holes, which would allow the passing of the light beam that goes through the holes and blocks the rest, leading to a specific invisible pattern into the target object. Therefore, such pattern cannot be seen by human eyes but can be discerned by the imaging device 14 to solve the correspondence problem for 3D scenario reconstruction.

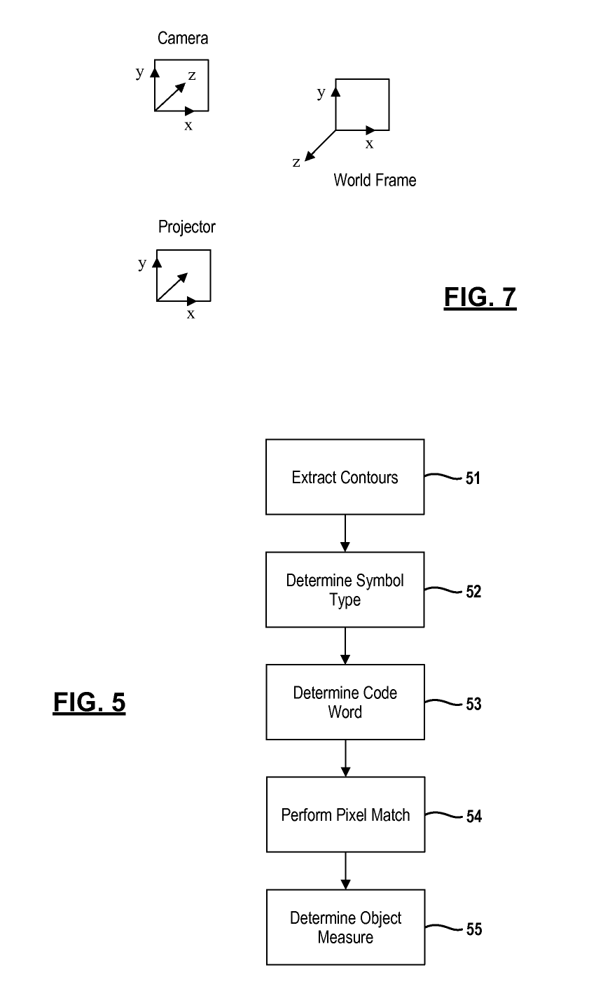

With reference to FIG. 5, pattern detection and identification is carried out by the image processor 16. Once the pattern is projected onto the scene, a single frame of image data is captured by the imaging device 14. The image processing of the image data is simple because the primitives are designed on the black background and separated enough.

First, the image processor 16 extracts a contour at 51 for each symbol in the image data. Suitable contour extraction techniques are readily known in the art. Given that the inspected surface is locally smooth and a strong gradient in the image intensity around the symbol boundary, the contour of the symbol is easily detected and can be implemented in real time. Additionally, it is less sensitive to reflectivity variation and ambient illumination than threshold based segmentation.

Symbol recognition can be achieved in different manners. In an exemplary embodiment, symbol recognition is achieved at 52 from a symbol's orientation in relation to the epipolar line. The moment of geometrical primitive is represented as:

Mⱼₖ=∫_{-∞}^{∞}x^{j}y^{k}f(x,y)dxdy (6)

The coordinates of the mass center are denoted as:

Xₘ=M₁₀/M₀₀; Yₘ=M₀₁/M₀₀ (7)

The angle between the principal axes and x axes is:

$$a = \frac{1}{2} acr tan ( \frac{2 {M}_{11}}{{M}_{20} - {M}_{02}} ) \qquad ( 8 )$$

Hence, the mass center of the contour is detected, for example, by (7) and is regarded as the initial rough location of the primitive. Then, the fine location of the primitive is determined, for example, by the Harris algorithm within a local region for corner detection. Consequently, the principal axes are extracted. An exemplary extraction technique is further described in “Disordered Patterns Projections for 3D Motion Recovering”, by D. Boley and R. Maier, 3DPVT, Thessaloniki, Greece, 2004. In fact, two perpendicular axes can be extracted, long axis and short axis. The long or longitudinal axis is regarded as the principal axis. Then directions of the principal axis and the epipolar line are compared to determine the symbol.

Codewords are then determined at 53 for each pixel in the image data. In an exemplary embodiment, a codeword is derived as a function of its value and values of at least two adjacent pixels. For example, if one primitive value is 2 and its left and right neighbor values are 1 and 3, then its codeword can be calculated as 1×4²+2×4¹+3×4⁰=27. It is envisioned that codewords may be derived using other functions. Additionally, codewords may be derived from values of other neighbors and/or primitives adjacent to the neighbors. When constructing a pattern of light, functions for deriving codewords are selected such that each codeword is unique.

Next, pixel matching will be performed 54 between the light pattern and the image data. That is, position of a given codeword in the image data is mapped to a position for a corresponding codeword in the light pattern. In an exemplary embodiment, the leftmost primitive on the imaging device image plane is selected as the matching window to find the corresponding primitive on the projector image plane. Then the matching windows both on the imaging device and projector image plane are shifted to the next primitive. A diagram of this recursive search algorithm is shown in FIG. 6. The procedure will be performed by the recursive search algorithm until all corresponding primitives are found out.

Corresponding pixels in the projector and the imaging device satisfy the epipolar constraint (1). However, the detected corresponding pixels may not exactly satisfy (1) due to the uncertainty of image processing. To solve such a problem, the modified pixels satisfying (1) are calculated by minimizing the sum of square distance:

E=∥x_{c}−x′_{c}∥²+∥xₚ−x′ₚ∥² (9)

where x′_{c}, x′ₚ are the optimal locations in the imaging device and projector image plane. Further details for solving such problems may be found, for example, in an article by K. Kanatani “Statistical Optimization for Geometric Computation: Theory and Practice Elsevier”, Amsterdam, the Netherlands, 1996.

Lastly, measurements for the object may be determined at 55. Given a position of a codeword in the image data and a position of a corresponding codeword in the pattern of light, a measurement for the pixel may be computed using triangulation techniques known in the art.

The accurate reconstruction of the 3D shape requires the proper calibration of each component used in the inspection system 10. In the inspection system, an imaging device 14 is denoted using a pinhole model due to the slight distortion of the lens. Thus, the coordinate transformation from the world frame to the image frame can be expressed as:

sI=AFX (10)

where I=[r,c,1]^{T} is the homogeneous coordinate of the pixel in the image frame;

X=[x,y,z,1]^{T} is the homogeneous coordinate of the corresponding point in the world frame; s is a scale factor; F is the extrinsic parameters representing the rotation and translation between the imaging device frame and world frame; A is the imaging device intrinsic parameters matrix and can be written as:

$$A = [ \begin{matrix}a & γ & {r}_{0} \\ 0 & β & {c}_{0} \\ 0 & 0 & 1\end{matrix} ]$$

where rₒ and cₒ are the coordinate of the principle point; α and β are focal length along the r and c axes of the image plane; γ is the parameter representing the skew of the two image axes.

The imaging device 14 can be calibrated using a checkerboard placed in different positions and orientations described, for example, by Zhang in “A flexible new technique for imaging device calibration”, IEEE Trans on Pattern Analysis and Machine Intelligence, Vol. 22, 2000 pp 1330-1334. To ensure that the imaging device can recognize the fringe patterns projected in the area of checkerboard during the projector calibration, the flat checkerboard is a red/blue checkerboard with size 15×15 mm rather than a black/white one.

Similarly, a projector 12 can also be considered as an inverse imaging device since it projects images instead of capturing them. Thus, once the coordinates of point in the world frame and that in the projector plane can be known, the calibration can be achieved using the same strategy for imaging device calibration. Therefore, a series of vertical and horizontal GCLS fringe patterns are projected onto the checkerboard and the phase distribution of the Xpoint in the projector image plane can be obtained through the images captured by imaging device 14. Then the projector 12 can be calibrated as imaging device calibration.

The next step is to calibrate the entire structured light inspection system 10. For this purpose, a uniform world frame for the imaging device and projector is established based on one calibration image with xy axes on the plane and z axis perpendicular to the plane shown as FIG. 7. In addition, the coordinates of the corresponding pixels on the imaging device and projector image planes are also used to calibrate the fundamental matrix and rectify the epipolar line.

In one aspect of this disclosure, an approach is presented for real time 3D shape measurement based on structured light. To solve the correspondence problem between the imaging device and projector, a one shot structured light pattern is presented. The concept of one shot projection of pseudo-random sequence along the epipolar line is introduced to accelerate the pattern identification. A robust primitive for the light pattern is also developed. Besides, the orientation of the primitive is used to encode the pattern. Moreover, the structured light pattern is designed using monochromatic light which will reduce the affection of the ambience light and the part reflection.

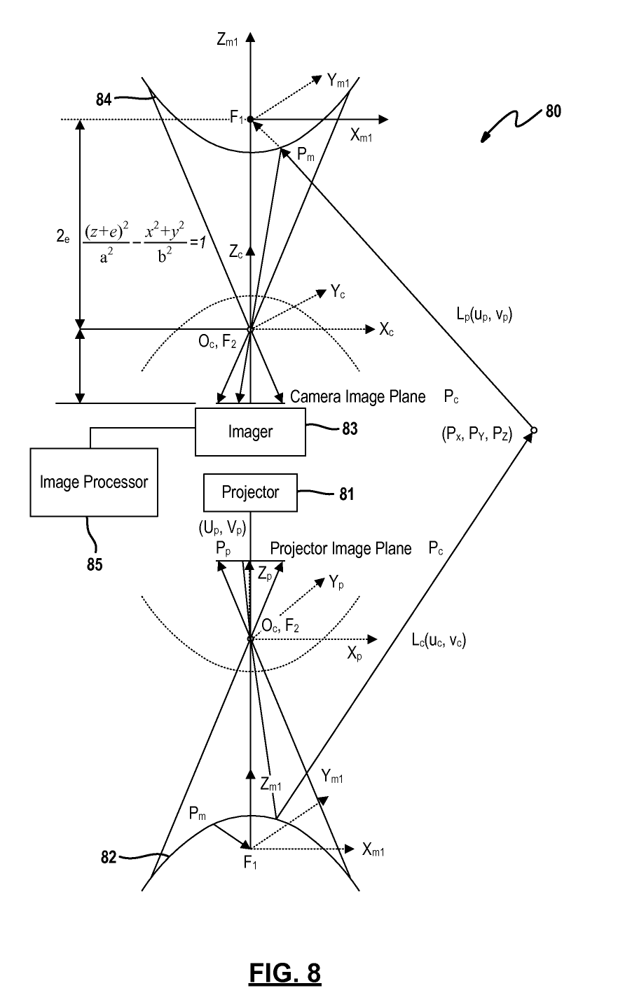

In another aspect of this disclosure, the improved structured light pattern may be extended to develop an omnidirectional three dimensional inspection system 80. Referring to FIG. 8, the inspection system 80 is comprised generally of a projector 81, a first mirrored surface 82, an imaging device 83, a second mirrored surface 84 and an image processor 85. The projector 81 operates to project a pattern of light in a projected direction towards an image plane and onto the first mirrored surface 82. The mirrored surface has a hyperbolic shape, such that the pattern of light is projected as an omnidirectional ring about the projector 81. The imaging device 83 is disposed adjacent to the projector 81. The imaging device 83 is arranged such that its image plane is in parallel with the image plane of the projector 81 and thus configured to capture image data reflected from the second mirrored surface 84. The second mirrored surface also has a hyperbolic shape and faces towards the first mirrored surface 82. The image processor 85 is configured to receive image data from the imaging device 83 and determine a measure for an object from the image data by using the pattern of light projected by the projector 81.

Under ideal condition, optical centers of the projector 81 and imaging device 83 coincide with the focal points Fₘ₁², Fₘ₂² of the two hyperbolic mirrors, respectively. The projector 81 is regarded as an inverse camera; that is, the projector 81 maps a 2D pixel in the projector to a 3D array in the scene. The optical path of the 3D camera can be described as follows: a light ray from the projector 81 goes through the focal point Fₘ₂² and then intersects with the first hyperbolic mirror 82 at point Pₘ₂. A hyperbolic mirror has a useful property that any light ray going towards one of the focal points will be reflected through the other focal point. Hence, the incident light ray will be reflected away from the other focal point Fₘ₂¹. Then, it intersects with an observed target with diffuse reflection property so that part of the light ray will be reflected to the focal point Fₘ₁¹ of the second hyperbolic mirror 84; thus, the light ray will be further reflected at point Pₘ₁ of the hyperbolic mirror 84 to the imaging device 83 through the other focal point Fₘ₁² due to the property of the hyperbolic mirror. Therefore, under ideal condition, the relation between any 3D point in the scene and the corresponding 2D point in the image sensor can be represented by a uniform model with a single viewpoint.

However, the above ideal mathematical model requires the lens' optical center to coincide with focal point of the hyperbolic mirror. This requirement, however, is difficult to be completely satisfied, especially for the projector 81 since it cannot view the scene directly. So the uniform model for every pixel of the sensor will cause the residual error, resulting in incorrect 3D reconstruction.

To solve such a problem, a vector-based 3D reconstruction strategy which determines the ray vector for each pixel of the imaging device and projector in the scene was proposed and the corresponding look-up-tables (LUT) was established to calibrate the system. A light array Lₚ(uₚ,vₚ) from a projector pixel (uₚ,vᵥ) intersects its corresponding light array from the imaging device L_{c}(u_{c},v_{c}). The intersection point P is the reconstruction point. Instead of reconstructing the light array from the image pixel, light arrays are directly rebuilt in the task space:

Lₚ=P_{w}¹+\vec{U}_{w}_{ₚ}_{λ}_{ₚ} (11)

L_{c}=Q_{w}¹+\vec{V}_{w}_{_{c}}_{λ}_{_{c}} (12)

P_{w}¹ is an arbitrary point on Lₚ and U_{w} is a unit vector representing its direction. Q_{w}¹ and V_{w} in Equation 12 have the similar meanings.

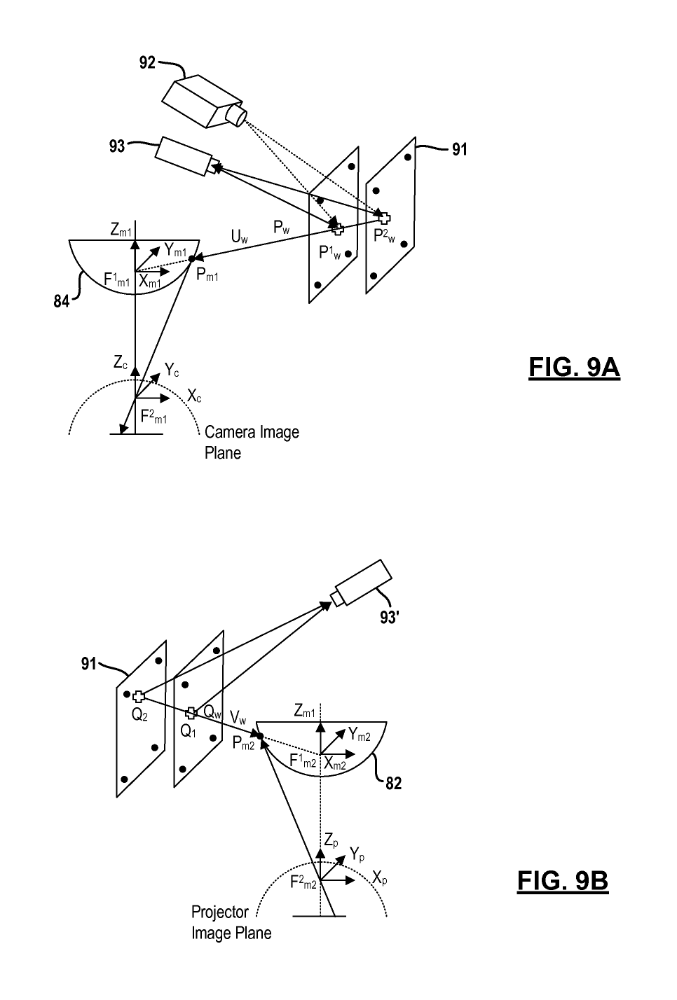

First, calibration of the omnidirectional inspection system 80 is discussed using a vector-based calibration strategy. As shown in FIG. 9A, U_{w} is the incident vector in the world frame of a pixel l_{c} in the catadioptric camera, which is the calibration parameter for each pixel. By moving a predefined reference board 91 (white flat board) with several precise-located markers, the view vector U_{w}, can be specified by the points P_{w}¹ and P_{w}². Although the calibration concept is straightforward, it is a challenge to calibrate all the pixels simultaneously.

To this end, an extra dioptric projector 92, as well as dioptric camera 93, is introduced. The dioptric projector 92 shoots two-dimensional encoded patterns onto the reference board 91; meanwhile, the dioptric camera 93 records the resulting image of the board 91. In such a way, the phase value can be determined for each pixel in the dioptric camera 93. The origin of the reference board frame is set to coincide with one marker and the xy axes are parallel to reference board 91. Obviously, the z axis is perpendicular to the reference board 91. In this case, the coordinate Pᵣ in the reference board frame can be transformed to the corresponding l′_{c} in the image plane frame of the dioptric camera 93 by the homography matrix H:

Pᵣ=H×I′_{c} (13)

where H can be specified by using the markers on the reference board 91 since the coordinates of these markers in the image plane frame and reference board frame are both known. It should be pointed out that the location Pᵣ can be calculated within the sub-pixel by appropriate image processing.

The desired location P_{w} of the point is measured in the world frame. Therefore, the location Pᵣ in the reference board frame should be further transformed to P_{w} in the world frame:

P_{w}=RPᵣ+t (14)

where the 3×3 rotation matrix R and 3×1 translation vector t can be obtained through the known markers. Markers are measured using a high accuracy instrument (e.g., the measuring arm or laser tracker), which is kept static during the calibration procedure so that the instrument frame is considered as the world frame; whereas, the dioptric projector 92 and the dioptric camera 93 are moved to optimal position in sequence when the reference board 91 is placed at different sides.

Furthermore, the illuminated patterns are simultaneously captured by the catadioptric camera 93 so that the corresponding coordinate P_{w}¹ in the world frame can be determined for every pixel in catadioptric camera 93. Similarly, the coordinate P_{w}² can be obtained when the reference board 91 is moved to another location. Then, the reflected vector U_{w} and a point P_{w}¹ for each pixel in the world frame can establish a LUT, whose size is equal to the resolution of the catadioptric camera 93. Without loss of generality, any point viewed in the catadioptric camera 93 can be presented by:

P_{w}=P_{w}¹+αU_{w} (15)

where α is a scale factor;

$${U}_{w} = \frac{{p}_{w}^{2} - {p}_{w}^{1}}{\vert {p}_{w}^{2} - {p}_{w}^{1} \vert} .$$

It should be noted that the point viewed within the pixel in the catadioptric camera 93 can be realized by using bilinear interpolation with four neighboring pixels.

On the other hand, calibration of the catadioptric projector can be achieved in a similar way except with the absence of the extra dioptric projector 92. For this technique, encoded patterns are directly shot from the catadioptric projector and the dioptric camera 93′ records the phase distribution and calculates the corresponding locations Qᵣ¹ and Qᵣ² in the reference board frame. Similarly, markers on the reference board 91 are measured by the high accuracy instrument so that the locations Qᵣ¹ and Qᵣ² in the world frame are obtained. Hence, any point on the incident light ray of the projector 81 can be expressed by:

Q_{w}=Q_{w}¹+βV_{w} (16)

where β is a scale factor;

$${V}_{w} = \frac{{Q}_{w}^{2} - {Q}_{w}^{1}}{\vert {Q}_{w}^{2} - {Q}_{w}^{1} \vert} .$$

Eventually, the incident vector v_{w} and a point Q_{w}¹ for each pixel of the catadioptric projector 92 can also establish a LUT, whose size is equal to the resolution of the catadioptric projector 92.

Once projector 81 and camera 83 are calibrated, the point on the observed target can be computed by the intersection of the two vectors of the projector and camera.

A robust projection pattern is critically important for achieving accurate correspondence for a structured light based inspection system 80. The design should satisfy the following constraints: (a) monochromatic light and (b) pre-warping to cancel mirror distortion and (c) invariance from scene variation. In an exemplary embodiment, the structured light pattern is constructed in the manner set forth above although other types of light patterns meeting these constraints also fall within the broader aspects of this disclosure. However, such a pattern only works fine in a normal structured light inspection system 10, it could not be used in the omnidirectional structured inspection system 80 without pre-warping. The convex shape mirrors in the omnidirectional inspection system 80 could distort both the geometries and the orientations of the primitives. Compared with traditional monochromatic light based patterns, light arrays are warped by the hyperbolic mirror twice in an omnidirectional system 80. Hence, the geometric features based pattern is even more difficult to be calculated compared with the detection scheme described above. The wanted projection image should be first un-warped in order to cancel the mirror distortion. Since a projector cannot receive information, its pre-warp function is much more difficult than an imaging device. Second, even if the un-warping function is calculated, the projected geometrical light features are still further arbitrarily distorted by the unknown environment. The designs of the primitives should also be an invariant from this distortion and then a correct correspondence can be linked between two image frames.

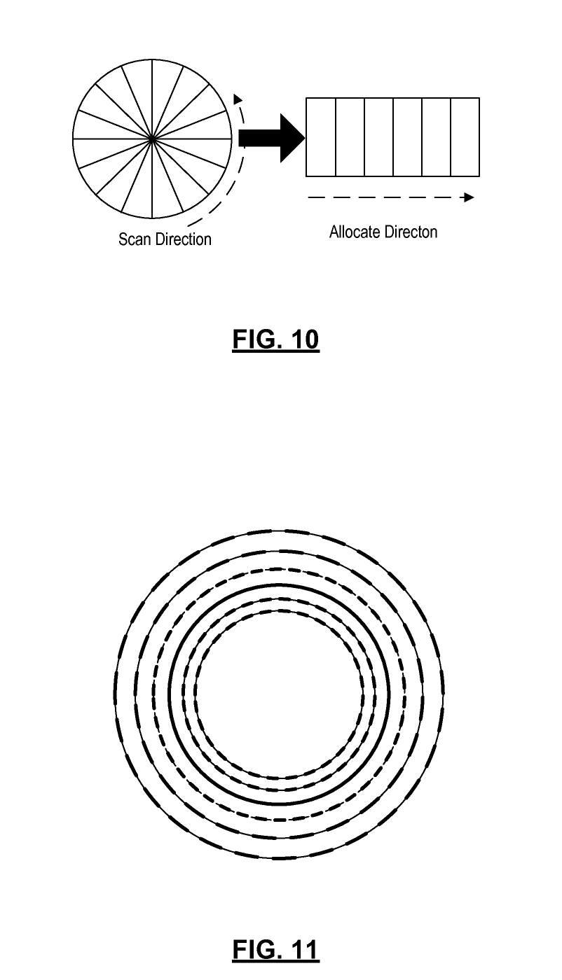

Both of the projector warp and the camera warp are the transformations between a conic image to a panoramic view. Camera image warp has been discussed in the past. In essence, the warping function scans the conic image around the center and then horizontally allocates each part into a rectangle as shown in FIG. 10. The radius and the center of the conic image are needed to finish the warping process. The radius and the center can be easily obtained for an imaging device 83 in omnidirectional system 80 by image analysis, but the warp for the projector 81 is much more difficult and has been discussed very little in literature.

If the projector is center symmetric, such as a gobo projector, the center of the conic image can be considered as its image center. The radius is the distance between the image center to the image edge. If the projector is not center symmetric, such as a traditional LCD/DLP projector, its center of the conic image cannot be directly estimated, since a projector is not an information receiving device. Through the LUT created in the calibration process, the projector can ‘view’ the scene by a calibrated camera, which is illustrated in FIG. 9B. By treating the omni-projector as a pseudo omni-camera, its warping function can also be obtained by LUT. Basically, the designed projection marks are first calculated on the reference board 91 in the world frame and then are transferred back to the projector image frame via LUT. Hence, the conic image center and its radius can be interpolated.

The task to design a one-shot projection is to assign each projected bright pixel/image primitive/marker one unique codeword to distinguish each other. The unique codeword will bring correspondence between two image frames. FIG. 11 illustrates an exemplary projection pattern with concentric circles designed for one-shot projection. After the center of conic projector image is derived, concentric circles with different radii are utilized as the projection pattern. There are two parts of the encoding algorithm: the assignment of a unique circle codeword to each ring and the assignment of a unique pixel codeword along a circle.

There are several methods to assign circle codeword. The first method is to assign a different intensity value to each circle. Obviously, a circle with intensity 50 can be easily separated from a circle with intensity 100. The projection intensity can be used as a feature/codeword to separate each circle.

The second method is to assign different width of each circle. Since each circle has different width, separation of each circle can be easily achieved.

The third method is to assign different angular frequencies to the circles. Each circle is assigned by a different angular frequency (i.e. spacing between symbols along the circle) and different projection intensity in order to distinguish each other. The intensity functions of the concentric circles are described by equation 17 using the inverse Fast Fourier Transform (FFT). In the exemplary embodiment, the intensity function

$${I}_{p} ( r , \frac{N}{2 π} θ )$$

is designed in the polar coordinates, where r stands for the radius and θ is the angle. N is the number points on the circle. X(r,k) is the assigned angular frequency for each circle and Iᵣ is the intensity coefficient for each circle.

$$\begin{matrix}{I}_{P} ( r , \frac{N}{2 π} θ ) = \{ \begin{matrix}\frac{1}{N} {I}_{r} {\sum }_{k = 1}^{N} X ( r , k ) {ω}_{N}^{- ( \frac{N}{2 x} θ - 1 ) ( k - 1 )} , & if r = {R}_{1} , … , {R}_{10} \\ 0 , & else\end{matrix} & ( 17 ) \\ {ω}_{N} = {e}^{( - 2 π i ) / N} & ( 18 )\end{matrix}$$

Compared with sinusoid wave, square wave is more robust against image noise. The peak values in its spectrum are used as its circle codeword to identify itself to the others.

The fourth method is to utilize the ratio between bright pixels and dark pixels as a circle codeword when a square wave is combined with a circle. For instance, there are 4 bright pixels and 4 dark pixels in a period in the first square wave and there are 6 bright pixels and 3 dark pixels in a period in the second square wave. When both square waves are combined to different circles, these two circles can be easily separated each other via the ratio between bright and dark pixels.

The fifth method is to apply spatial neighbors method to create a circle's codeword. The circle's codeword is derived as a function of its value and values of its two adjacent circles. If there are n primitive values for the circles, spatial neighbors method could assign n³ codewords and distinguish n³ circles in total. For instance, if one circle value is value 1 and its inner and outer neighbor circles' values are 2 and 3. There are totally three different kinds of codewords, and then its circle codeword can be calculated as 2×3⁰±1×3¹+3×3²=32. The spatial neighbors method could create totally 3³=27 codewords in this example. Additionally, it is envisioned that the codeword function is not unique but any functions can create an identity value for a circle.

The task for a one-shot pattern decoding algorithm is to extract the designed codeword so as to establish the correspondence between a projector pixel and a camera pixel. The decoding algorithm also has two parts: extraction of the circle codeword and extraction of pixel codeword along a circle. Since five encoding methods are listed to assign unique feature/codeword to each circle, five corresponding decoding methods are introduced too.

For the first method, the received intensity is used to extract the designed codeword. For the second method, the received circle width is used to extract the codeword. For the third and fourth methods, epipolar constraints are utilized to extract the codeword. As the objects depths vary, the corresponding camera pixel changes its position. However, there are still certain rules that it must follow. As shown in FIG. 12, a projector pixel Iₚ(rₚ, 0) emits a light array, intersects to the scene at point P, and reflects into the camera image plane at point I_{c}(r_{c},θ). No matter where P is, Iₚ and I_{c} always share the same phase angle θ and θ is the invariant component from the scene. In this disclosure, the received angular frequency of each circle can also be derived through FFT:

$$X ( r , k ) = {\sum }_{j = 1}^{N} {l}_{c} ( r , j ) {ω}_{N}^{( j - 1 ) ( k - 1 )} \qquad ( 10 )$$

A codeword of a circle can be extracted in the camera frame and is compared with the codeword in the projector frame. Due to the random image noise, the epipolar constrain may not be perfectly satisfied. To solve such a problem, a predefined threshold is used to compare both codewords.

The second part is to separate pixels along a received image circle. Since each camera pixel has the same phase angle θ with its corresponding projector pixel based on epipolar constraints, the received camera pixel's phase angle can be directly applied as its pixel codeword. After both parts are done: extraction of circle codeword and extraction of pixel codeword, pixel-wised correspondence between camera image frame and projector image frame is established.

Image processing techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for performing three-dimensional shape inspection, comprising:
generating a pseudorandom sequence of values;
constructing, from the pseudorandom sequence of values, a pattern of light comprised of a plurality of symbols, where each type of symbol in the pattern of light having a different geometric shape and encoding a different value in the pseudorandom sequence of values;
projecting the pattern of light from a light projector onto an object of interest, where the pattern of light is projected along an epipolar line defined by an intersection of an epipolar plane with an image plane of the light projector;
capturing image data indicative of the object using an imaging device; and
determining a measure for the object from the image data and the pattern of light projected onto the object.

2. The computer-implemented method of claim 1 further comprises defining geometric shapes having a longitudinal axis and encoding different values in the pseudorandom sequence of values based on orientation of the longitudinal axis of the geometric shape in relation to the epipolar line.

3. The computer-implemented method of claim 1 further comprises constructing a pattern of light by arranging the plurality of symbols in a two dimensional array, such that each row in the array of symbols aligns with an epipolar line.

4. The computer-implemented method of claim 1 wherein capturing image data of the scene further comprises arranging scan lines of the image plane of the projector and scan lines of the image plane of the imaging device in parallel with a line connecting an optical center of the projector with an optical center of the imaging device.

5. The computer-implemented method of claim 1 further comprises deriving a codeword for each symbol in the pattern of light, such that each codeword is unique.

6. The computer-implemented method of claim 5 further comprises deriving a given codeword as a function of its value in the pseudorandom sequence and at least two adjacent values in the pseudorandom sequence.

7. The computer-implemented method of claim 5 wherein determining a measure for the object further comprises:
determining a symbol type for a given pixel in the image data;
determining a codeword for the given pixel in the image data;
identifying a codeword in the pattern of light that corresponds to the codeword for the given pixel; and
determining a measurement for the object using triangulation between position of the codeword in the image data and position of the corresponding codeword in the pattern of light.

8. A computer-implemented method for performing three-dimensional shape inspection, comprising:
projecting the pattern of light from a light projector onto an object of interest, wherein the pattern of light is comprised of a plurality of symbols having different geometric shapes and is projected along an epipolar line defined by an intersection of an epipolar plane with an image plane of the light projector;
capturing image data indicative of the object using an imaging device, where a scan line in the image data is aligned with an epipolar line defined by an intersection of an epipolar plane with an image plane of the imaging device;
determining position of a given symbol in the image data and position of the given symbol in the pattern of light projected onto the object; and
determining a measurement for the object using triangulation between the position of the given symbol in the image data and its corresponding position in the pattern of light.

9. The computer-implemented method of claim 8 further comprises constructing the pattern of light from a pseudorandom sequence of values, such that each type of symbol in the pattern of light encodes a value in the pseudorandom sequence of values using orientation of a longitudinal axis of its geometric shape in relation to the epipolar line.

10. The computer-implemented method of claim 9 further comprises
deriving a codeword for each symbol in the pattern of light, such that each codeword is unique;
determining a symbol type for a given pixel in the image data;
determining the codeword for the given pixel in the image data;
identifying a codeword in the pattern of light that corresponds to the codeword for the given pixel; and
determining a measurement for the object using triangulation between position of the codeword in the image data and position of the corresponding codeword in the pattern of light.

11. The computer-implemented method of claim 1 further comprises constructing a pattern of light by arranging the plurality of symbols in a two dimensional array, such that each row in the array of symbols aligns with an epipolar line.

12. A non-contact inspection system for real-time three-dimensional shape inspection, comprising:
a projector operable to project a pattern of light onto an object of interest, wherein the pattern of light is comprised of a plurality of symbols and is projected along an epipolar line defined by an intersection of an epipolar plane with an image plane of the light projector, such that each type of symbol in the pattern of light has a different geometric shape and encodes a value from a pseudorandom sequence of values;
an imaging device configured to capture image data indicative of the object, where a scan line in the image data is aligned with an epipolar line defined by an intersection of an epipolar plane with an image plane of the imaging device; and
an image processor configured to receive the image data from the imaging device and operable to determine a measure for the object from the image data by using the pattern of light projected onto the object.

13. The non-contact inspection system of claim 12 wherein the projector projects a pattern of light having the plurality of symbols arranged in a two dimensional array, such that each row in the array of symbols aligns with an epipolar line.

14. The non-contact inspection system of claim 12 wherein each symbol in the pattern of light has a longitudinal axis such that values in the pseudorandom sequence of values are encoded based on orientation of the longitudinal axis of the symbol in relation to the epipolar line.

15. The non-contact inspection system of claim 12 wherein the image processor determines a codeword for each symbol in the pattern of light such that each codeword in the pattern of light is unique and derived as a function of a value encoded by the corresponding symbol and values encoded by at least two symbols adjacent to the corresponding symbol.

16. The non-contact inspection system of claim 15 wherein the image processor determines a measure for the object by determining a symbol type for a given pixel in the image data; determines a codeword for the given pixel in the image data; identifying a codeword in the pattern of light that corresponds to the codeword for the given pixel; and determines a measurement for the object using triangulation between position of the codeword in the image data and position of the corresponding codeword in the pattern of light.

17. The non-contact inspection system of claim 12 wherein the projector projects a pattern of light that is infrared.

18. The non-contact inspection system of claim 12 wherein imaging device is further defined as a charge-coupled device.

19. The non-contact inspection system of claim 12 wherein projector projects the pattern of light along scan lines and the imaging device captures image data along scan lines, such that the scan lines of the projector are arranged in parallel to the scan lines of the imaging device and in parallel with a line connecting an optical center of the projector with an optical center of the imaging device.

20. An automated method for performing three-dimensional shape inspection, comprising:
projecting a pattern of light from a light projector onto an object of interest, wherein the pattern of light is comprised of a plurality of symbols having different geometric shapes and projected in an omnidirectional plane about the projector;
capturing image data indicative of the object using an imaging device;
determining position of a given symbol in the image data, where the given symbol is one of the plurality of symbols;
determining position of the given symbol in the pattern of light projected onto the object; and
determining a measurement for the object using triangulation between the position of the given symbol in the image data and its corresponding position in the pattern of light.

21. The automated method of claim 20 further comprises constructing the pattern of light as a plurality of concentric circles, each circle having a different radius.

22. The automated method of claim 21 further comprises constructing the pattern of light such that each circle is comprised of symbols spaced apart and the spacing between symbols varies amongst the circles.

23. The automated method of claim 22 further comprises constructing the pattern of light from a pseudorandom sequence of values, such that each type of symbol in the pattern of light encodes a value in the pseudorandom sequence of values using orientation of a longitudinal axis of its geometric shape in relation to an epipolar line.

24. The automated method of claim 23 further comprises deriving a codeword for each symbol in the pattern of light, such that each codeword is unique and derived as a function of spacing between symbols and light intensity.

25. The automated method of claim 24 further comprises deriving a given codeword from a value encoded by the corresponding symbol and values encoded by at least two symbols adjacent to the corresponding symbol.

26. The automated method of claim 25 further comprises
determining a type of symbol for a given pixel in the image data;
determining the codeword for the given pixel in the image data;
identifying a codeword in the pattern of light that corresponds to the codeword for the given pixel; and
determining a measurement for the object using triangulation between position of the codeword in the image data and position of the corresponding codeword in the pattern of light.

27. The automated method of claim 21 further comprises constructing each circle in the pattern of light to have a different light intensity.

28. The automated method of claim 21 further comprises constructing each circle in the pattern of light as a line of light having a different width.

29. The automated method of claim 21 further comprises projecting a pattern of light that is infrared.

30. A non-contact inspection system for real-time three-dimensional shape inspection, comprising:
a projector operable to project a pattern of light in a projected direction towards an image plane and onto a first mirrored surface having a hyperbolic shape, such that the pattern of light is projected as omnidirectional ring about the projector;
an imaging device disposed adjacent to the projector and having an image plane arranged in parallel with the image plane of the projector, wherein the imaging device is configured to capture image data reflected from a second mirrored surface having a hyperbolic shape, such that the second mirrored surface is facing towards the first mirrored surface; and
an image processor configured to receive the image data from the imaging device and operable to determine a measure for an object from the image data by using the pattern of light projected by the projector.

31. The non-contact inspection system of claim 30 wherein the projector projects a pattern of light as a plurality of concentric circles, each circle having a different radius and a different light intensity.

32. The non-contact inspection system of claim 31 wherein the each circle in the pattern of light is comprised of a plurality of symbols having different geometric shapes and spaced apart from each other, such that spacing between symbols varies amongst the circles.

33. The non-contact inspection system of claim 32 wherein the pattern of light is constructed from a pseudorandom sequence of values, such that each type of symbol in the pattern of light encodes a value in the pseudorandom sequence of values using orientation of a longitudinal axis of its geometric shape in relation to an epipolar line.

34. The non-contact inspection system of claim 33 wherein the image processor determines a codeword for each symbol in the pattern of light such that each codeword in the pattern of light is unique and derived as a function of spacing between symbols and light intensity.

35. The non-contact inspection system of claim 34 wherein the image processor derives a given codeword from a value encoded by the corresponding symbol and values encoded by at least two symbols adjacent to the corresponding symbol.

36. The non-contact inspection system of claim 34 wherein the image processor determines a type of symbol for a given pixel in the image data; determines the codeword for the given pixel in the image data; identifies a codeword in the pattern of light that corresponds to the codeword for the given pixel; and determines a measurement for the object using triangulation between position of the codeword in the image data and position of the corresponding codeword in the pattern of light.
